(19) United States
(12) Patent Application Publication
(10) Pub. No.: US 2020/0403367 A1
(43) Pub. Date: Dec. 24, 2020

(54) CONFIRMATION OF THE LOCKING OF AN ELECTRICAL WIRE IN A CONNECTOR AND TOOL FOR THE IMPLEMENTATION THEREOF

(71) Applicant: SOURIAU, VERSAILLES CEDEX (FR)

(72) Inventors: Olivier FAURE, PARIS (FR); Danh PHAN, MAROLLES-EN-BRIE (FR)

(21) Appl. No.: 16/635,959

(22) PCT Filed: Jul. 20, 2018
(86) PCT No.: PCT/FR2018/051859

§ 371 Date: Jan. 31, 2020

(30) Foreign Application Priority Data
Aug. 2, 2017 (FR) 1757434

(51) Int. Cl. H01R 43/22; H01R 13/426

(52) U.S. Cl. CPC H01R 43/22; H01R 2201/20; H01R 13/426

(57) ABSTRACT

The invention relates to an insertion tool for an electrical connector, said tool comprising an elongated section, one end of which (distal end) is intended to be introduced into a connection port for a contact element of a wire of an electrical cable in the connector, the connection port being provided with a retention clip, the connector comprising one or more connection ports, characterised in that at least one portion of the elongated section is insulating and in that said insertion tool comprises: —a first electrical contact arranged at the distal end of the elongated section; a second electrical contact electrically isolated from the first electrical contact; said first and second electrical contacts being adapted to enter into electrical communication and generate a signal when the distal end is inserted into the retention clip.

### TECHNICAL FIELD OF THE INVENTION

The technical field of the invention is that of the tooling used in connectors.

More precisely, the invention relates to a tool for plugging the electrical contact of a wire into a connector.

The invention has a particularly useful use in mounting and checking the mounting of electrical contacts in a connector.

### PRIOR ART

Connectors are usually used to connect an electrical wire to another electrical wire or to a piece of equipment for example.

An electrical wire conventionally includes a contact element crimped to an end of the wire, this contact element is provided with a shoulder or a lug, which is sometimes annular.

The connectors include an insulating case defining connection ports. Each contact element is thus inserted into the connection port of the connector.

To ensure a retention of the contact element in the connector, each connector includes a retaining means intended for retaining the contact element in the connection port.

For example, the retaining means includes flexible blades. Each flexible blade extends from an inner wall defining the cavity towards the bottom of the connection port.

During the insertion of the contact element into the connection port, the lug of the contact element pushes the flexible blades back towards the wall of the connection port. When the lug goes beyond the distal end of the blade they are no longer in contact. The flexible blades thus return to their initial position insofar as the lug no longer exerts a radial stress on these flexible blades.

The lug of the contact element is then blocked in translation between a distal end of the connection port and the flexible blades. The extraction of the wire out of the cavity becomes impossible without a tool. It is said that the contact element is “locked” in the connection port and that the wire to which the contact element is crimped is “locked” in the connector.

To introduce a wire into a connector, an operator arranges an insertion tool on the wire. The insertion tool includes a hollow to be fitted onto a wire and onto the contact element.

The operator inserts the wire using the insertion tool. This operator slides the insertion tool along the wire to press an end of the insertion tool against the lug of the contact element of the wire. When the blades retain the contact element, the retraction of the insertion tool by the operator leaves the wire in the connection port of the connector.

It is crucial that a wire plugged into a connector does not get plugged out on its own, that is to say that it is correctly locked in its housing. An unplugging of the wire can cause a malfunction of the connector. Techniques for detecting the susceptibility of a wire to come out of the connector are known, despite the fact that the part plugged in is hidden in the connector.

In general, the operator pays attention to the “click” generated when the wire is locked in the connector. Unfortunately, this sound can be too faint to be heard, in particular in a noisy, vibrant environment such as a factory or a production workshop.

To overcome this problem, a user can test each wire after insertion into the connector, by carrying out a traction on the cable or on each of its wires to see if it comes out of the connector. A tool is also known allowing a user to test each wire by pushing its contact element against the front face of the connector, in order to make it move back if it is not properly plugged in.

In addition to representing an additional step, these techniques are not perfect. The operator can forget to test a wire and the force applied to the wire or to the contact during the confirmation may twist a pin, damage the wire and/or the connector and this stress is not applied in a repeatable manner since it is applied by hand.

Finally, a wire incorrectly plugged in may not come out of the connector despite the tensile stress since the friction between the wire(s) of the cable and the inside of the connector are too great. However, the vibrations to which the connectors are exposed (for example in aircraft or other vehicles) can make the wire in question come out.

To overcome these problems, it is routine today to use a tool allowing to plug a wire into a connector and to confirm that this wire is correctly plugged in. Of course, such tools are advantageous with respect to confirmation techniques carried out after the removal of the insertion tool, in that they allow to avoid possibly forgetting to check a wire and do not require an additional step in the assembly of the connectors.

Insertion tools comprising a gripping means are known. Such tools allow to insert the wire into the connector, then to confirm that this wire is correctly plugged in by pulling thereon. During the confirmation, the gripping means pulls on the wire, until a maximum level of traction. Once the maximum traction has been reached, the gripping means disconnects and frees the wire in order to reduce the risk of damaging the wire.

In all these techniques, the user is required to consider his/her inability (or that of the tool) to extract the wire as an indication that the wire is correctly plugged in and locked. However, the inability of a user, or of a tool, does not equal the total impossibility of extracting the cable. For example, a wire incorrectly plugged in can resist stresses seeking to unplug it (like during a traction test) then unplug itself on its own in the presence of the vibrations of an aircraft in flight. Often, this occurs when the wire incorrectly plugged in is retained inside the connector by friction with the other elements then is freed little by little due to vibrations of an aircraft in flight for example.

None of the current systems allow to simultaneously meet all the needs required, in particular to propose a technique for inserting the cable into the connector and at the same time validating that the latter is correctly locked inside.

### OBJECT OF THE INVENTION

The present invention aims to overcome all or a part of the disadvantages of the prior art mentioned above.

For this purpose, the object of the present invention is a method for confirming the locking of a contact element of an electrical cable by a retention clip, an insertion tool for the implementation of such a method for confirming the locking (that is to say capable of implementing the method for confirming the locking), a method for checking an insertion tool for determining the ability of the latter to be used in such a method for confirming the locking and a checking tool for the confirmation of the proper operation of the insertion tool.

The method for confirming the locking can take place simultaneously with the mounting of a connector (that is to say during the mounting), or after the mounting. The object of the present invention is also a particular mounting method.

According to the invention, the insertion tool is an insertion tool for an electrical connector, said tool comprising an elongated section, one end of which, distal, is intended to be inserted into a connection port for a contact element of a wire of an electrical cable in the connector, the connection port being provided with a retention clip, the connector comprising one or more connection ports, characterised in that at least a part of the elongated section is insulating and in that said insertion tool comprises:
a first electrical contact, disposed at the distal end of the elongated section;
a second electrical contact, electrically insulated from the first electrical contact;

said first and second electrical contacts being capable of entering into electric communication and with one another when the distal end is inserted into the retention clip.

“Electric communication” means a relationship between the electric current or electric potential measurable at two points. For example, if the first contact and the second contact are in series, the current circulating in the first electrical contact is substantially equal to the current circulating in the second electrical contact. It is thus said that the two contacts are in electric communication with one another. For example, if a current circulating in one of the contacts induces a current in the other of the contacts, it can be said that these contacts are in electric communication, with one another. For example, if an electric potential at one of the contacts modifies an electric potential at the other of the contacts, it can be said that these contacts are in electric communication, with one another. In other words, it is possible to transmit an electric signal between two points that are in electric communication, and this transmission is not possible when they are not in electric communication.

“Cable” or “electrical cable” means one or more electrical wires. Often, each wire is coated with an insulating material (also called “jacket” in English). An end or an ending of a wire is stripped to enter into electric communication with a contact element. The contact element is often welded to the ending or crimped around the stripped ending of the electrical wire.

“Contact element” means a female contact (also called a “socket”), a male contact (also called “pin”), a genderless contact, or any terminal or ending of a wire or electrical cable, particularly one that is at least partly made from a conductive material.

“Connection port” means an insulating housing (also called “cell”) configured to accept an electrical wire carrying a contact element. Often, a connection port is a cavity made between a body of an electrical connector (also called a “case” of an electrical connector) and an insulant (for example a joint) of the electrical connector. The body and the insulant are perforated to accept the wire and the contact element, respectively. The port is often provided with a retention clip disposed between the contact element and the insulant, which allows to lock the contact element in the contact port.

“Retention clip” means a retaining means comprising a substantially hollow body provided with one or more flexible internal projections (often called “strips”). The body of the retention clip (often called a “clip box”) is used to position the internal projections of the retention clip in a connection port, cooperating with the surfaces of this in such a way as to receive the contact element. During the passage of the contact element, the internal projections are deformed according to the external geometry of the contact element. During its insertion, the contact element goes beyond the proximal end of the internal projection of the retention clip before going beyond the distal end of the internal projection of the retention clip or the distal end of the body of the retention clip. Often, each internal projection extends simultaneously towards the inside and towards the distal end of the body of the retention clip.

Thus, the insertion tool allows to confirm the locking of a contact element on a wire of the cable in the connector, without a risk of damaging the cable or wire, its contact element or the connector. This confirmation can be done simultaneously to the connection of the cable or later. This confirmation is possible because the electrical insulation of the first and second contacts does not allow them signal transmission between them by default, but the insertion of the distal end of the insertion tool into the retention clip places the first and second contacts of the insertion tool in electric communication, and thus allows the transmission of a signal between them, by bypassing this electrical insulation. The possibility of transmitting a signal between the contacts can thus be considered as an indication that the insertion tool has reached the insertion depth necessary to achieve the locking of the cable by the retention clip.

According to one embodiment, said first and second electrical contacts are capable of entering into electric communication with one another when the distal end is inserted into the connection port and the contact element of the wire is locked by the retention clip.

Thus, the electric communication between the first and second electrical contacts (observed in particular by the possibility of transmitting a signal between these contacts) can be taken as an indication that the wire or cable is indeed retained by the retention clip—that is to say the contact element on the wire of the cable is locked by the retention clip—when the necessary insertion depth is reached by the insertion tool.

Often, a retention clip is at least partly made from conductive material in a region in contact with the insertion tool inserted therein.

According to one embodiment, the first electrical contact is disposed in such a way as to come in contact with the retention clip during the insertion of the distal end.

Thus, a conductive material of the retention clip enters into electric communication with the first electrical contact during the insertion of the insertion tool into the retention clip.

According to one embodiment, the second electrical contact is disposed in such a way as to come in contact with the retention clip during the insertion of the distal end.

Thus, a conductive material of the retention clip enters into electric communication with the second electrical contact during the insertion of the insertion tool into the retention clip.

According to one embodiment, the insertion tool further comprises a first part comprising the first and second electrical contacts, and a second part comprising an electric system, connecting the first electrical contact and the second electrical contact to a source of electric energy, the electric system comprising:
a third electrical contact to enter into electric communication with the first electrical contact, and
a fourth electrical contact, insulated from the third electrical contact, to enter into electric communication with the second electrical contact.

Thus, the insertion tool comprises means necessary for the generation of the signal, the possibility of transmission of which between the first and second contacts is taken as an indicator of the electric communication established by the insertion of the insertion tool into the retention clip.

According to one embodiment, the electric system comprises:
a means for detecting electric communication between the third and fourth electrical contacts; and
a means for signalling said electric communication between the third and fourth electrical contacts.

Thus, the insertion tool comprises means necessary for the detection of the electric communication established by the insertion of the insertion tool into the retention clip, and also to indicate its detection.

“Means for detecting electric communication” means a component or system which changes state when the electric communication between two points is detected.

“Signalling means” means a component or system that can begin to signal.

It is noted that the detection means can be of the type to control a signalling means that is located on another circuit. Such a configuration particularly is advantageous if a component of the insertion tool or of the connector could be damaged by the supply of power to the signalling means via a signal transmitted between the contacts of the insertion tool when the first and second contacts are in electric communication, with one another. Moreover, such a configuration could also reduce the energy consumption of the tool.

For example, a signal transmitted between the contacts of the insertion tool can be used to change the state of a detection means of the relay type (electric/static or electromechanical) or of the semiconductor type, which it uses to control the signalling means, which is disposed on a second circuit.

It is also noted that the detection means can be combined with the signalling means, in such a way that a component or system carries out both functions—detecting electric communication and signalling. Such a configuration is particularly advantageous when the signalling means can be powered using an electric signal transmitted between the contacts of the insertion tool, in particular because it allows to simplify the tool.

For example, if the signalling means is a component or system of the type that begins signalling as soon as it is powered, a signal transmitted between the contacts of the tool can be used to change the state of said component or system from the non-powered state to the powered state—a function of detection—and also power its signalling operation.

More concretely, if an indicator light is powered by a signal transmitted between the first and second electrical contacts, this light can be considered to be a detection means when it changes state (in this case non-powered to powered), and it can also be considered to be a signalling means because of its illumination (emission of a visual sensory light signal).

According to one embodiment, the signalling means comprises an emitter of a sensory and/or computer signal.

“Sensory signal” means a signal that can be detected by the human body. An emitter of a sensory signal can be a vibrator for a signal that is tactile, haptic or otherwise detectable by touch or kinaesthesia. For example, an emitter of a sensory signal can be an olfactory or taste emitter to generate an odour or a taste. For example, an emitter of a sensory signal can be a buzzer, a speaker, a horn or a vibrating membrane to emit a sound. For example, an emitter of a sensory signal can be a visual indicator, a light or other light indicator to emit a visual signal. “Computer signal” means a signal that can be detected by an electronic apparatus.

Thus, the insertion tool can communicate to a human being and/or to a computer system the detection or not of an electrical continuity established by the insertion of the insertion tool into the retention clip.

According to one embodiment the first part comprises:
a first conductive track, a first ending of which is the first electrical contact, to connect the first electrical contact to the third electrical contact
a second conductive track, electrically insulated from said first conductive track and in electric communication with the second electrical contact, and a first ending of which is the second electrical contact, to connect the second electrical contact to the fourth electrical contact.

Thus, the electric link between the first and second parts can be at a distance from the first and second electrical contacts of the first part. This allows to ensure that the electric link between the first and second parts does not disturb the insulation of the first and second contacts of the first part and the establishment of electric communication between them during the insertion of the insertion tool into the retention clip.

According to one embodiment, the third electrical contact is in contact with a second ending of the first conductive track, disposed at one end, proximal, of the first part or of the elongated section.

Thus, the third contact can be near the first contact without disturbing the establishment of electric communication between the first and second contacts by the insertion of the distal end into the retention clip.

According to one embodiment, the fourth electrical contact is in contact with a second ending of the second conductive track, disposed at one end, proximal, of the first part or of the elongated section.

Thus, the third and/or fourth contact is near the first and/or second contacts without disturbing the establishment of electric communication between the first and second contacts by the insertion of the distal end into the retention clip.

According to one embodiment, the insertion tool comprises a means for linking the elongated section to the second part.

Thus, if, for example, a problem occurs at one of the first and second parts, which may prevent the establishment of electric communication allowing to generate a signal between the first and second contacts of the first part, the defective part is easily replaced by a part that is not defective.

According to one embodiment, the linking means comprises a means for connection of the electrical contacts of the first part to electrical contacts of the electric system.

Thus, if, for example, a problem occurs at the contacts of one of the first and second parts, which may prevent the establishment of electric communication allowing to generate the signal between the first and second contacts of the first part, the defective contact is easily replaced by a contact that is not defective.

A wire or an electrical cable carrying a contact element is not retained if the contact element is not properly inserted into the retention clip—that is to say if the contact element has not moved forward enough in the retention clip. Thus, “proper insertion” means that the contact element has gone beyond the insertion depth necessary to be locked by the retention clip.

According to the invention, the confirmation method is a method for confirming the locking of a contact element of a wire or of an electrical cable by a retention clip in an electrical connector, characterised in that:
A) one end, distal, of an elongated section of an insertion tool is inserted between the retention clip and one end of the contact element, the insertion tool comprising a first electrical contact, disposed at said distal end, and a second electrical contact;
B) the first electrical contact is placed in electric communication with the second electrical contact via the retention clip when the contact element is locked in the connector by the retention clip, said first electrical contact being electrically insulated from said second electrical contact before the insertion of the insertion tool into said retention clip.

Thus, the possibility of transmitting a signal between the first and second electrical contacts of the insertion tool can be taken as an indication that the contact element is properly inserted into the retention clip, and should thus be retained. That is to say, the possibility of transmitting the signal indicates the locking of the contact element in the connector. Accordingly, the possibility of transmitting the signal can also be taken as an indication that the wire or the electrical cable is properly connected to the electrical connector.

According to the invention, the mounting method is a method for mounting a contact element of a wire or of an electrical cable in a retention clip of an electrical connector, characterised in that:
Aa) said contact element is inserted into said retention clip using a distal end of an elongated section of an insertion tool, said insertion tool comprising a first electrical contact disposed at said distal end and a second electrical contact;
Bb) said contact element is moved forward in said clip using said insertion tool;
Cc) the first electrical contact is placed in electric communication with the second electrical contact via said retention clip when the contact element is locked in the connector by said retention clip, said first electrical contact being electrically insulated from said second electrical contact before the insertion of the insertion tool into said clip.

Thus, it can be determined whether a contact element is properly inserted into the retention clip, and thus locked in the connector by the retention clip, during the mounting of the contact element to the connector.

It is noted that the confirmation method described above is carried out during the performing of the mounting method described above. Indeed, this is therefore an embodiment of the confirmation method, carried out during a method for mounting the contact element in the retention clip of the electrical connector, wherein
Aa) said contact element is inserted into said retention clip using the distal end of the elongated section of the insertion tool;
Bb) said contact element is moved forward in said clip using said insertion tool until the contact element is locked in the connector by the retention clip and the distal end of the insertion tool is disposed between the retention clip and the contact element.

According to one embodiment, the confirmation method comprises a method for checking the insertion tool.

Thus, it can be determined whether the tool is capable of implementing the confirmation (and optionally mounting, if necessary) method.

According to the invention, the method for checking the insertion tool is characterised in that:
Aaa) an electrical insulation of a first electrical contact of the insertion tool from a second electrical contact is confirmed, said first electrical contact being disposed towards one end, distal, of an elongated section of the insertion tool, at least one part of the elongated section being insulating;
Bbb) an electrical continuity at the first electrical contact is confirmed.

Thus, it can be detected whether the insertion tool is liable to falsely indicate the proper insertion of a contact element into a retention clip, and also whether it is liable to neglect to indicate the proper insertion of a contact element into a retention clip. That is to say, this checking method allows to detect the susceptibility of an insertion tool to falsely indicate the locking of the contact element in a connector by a retention clip, as well as the susceptibility of an insertion tool to neglect to indicate the locking of the contact element in a connector by a retention clip.

According to one embodiment,
Ccc) an electrical circuit is closed via the first electrical contact of the insertion tool.

Thus, it can be determined whether the insertion tool is liable to neglect to indicate the proper insertion of a contact element into a retention clip because the insertion tool is defective at its first electrical contact or whether it is rather defective between its first and second electrical contacts. That is to say, it can thus be determined whether an insertion tool is liable to neglect to indicate the locking of the contact element in a connector by a retention clip because the insertion tool is defective at its first electrical contact or whether it is rather defective between its first and second electrical contacts.

Given that the main interest of a method for checking the insertion tool is to determine whether it is capable of implementing the confirmation (and optionally mounting) method, it is clear that the confirmation method can also comprise any one of the alternatives of the checking method presented above.

According to one embodiment the confirmation method comprises a method for checking the insertion tool, wherein:
Aaa) an electrical insulation of the first electrical contact of the insertion tool and of the second electrical contact of the insertion tool is confirmed;
Bbb) an electrical continuity at the first electrical contact is confirmed.

According to one embodiment, the confirmation method comprises a step in which:
Ccc) an electrical circuit is closed via the first electrical contact of the insertion tool.

This checking method (or sub-method) can, advantageously, be implemented using a checking tool.

It is understood that an insertion tool is in a “functional”—that is to say “non-defective”—state if the insertion of its distal end into a retention clip retaining a wire or an electrical cable by its contact element places the first and second contacts in electric communication, with one another, via said retention clip (according to certain embodiments), and allows the generation of a signal, and if the removal of its distal end from the retention clip places the first and second contacts out of electric communication, with one another. That is to say, the insertion tool is in a “function”/“non-defective” state if the insertion of its distal end into a connection port in which a contact element is locked by a retention clip places the first and second contacts of the insertion tool in electric communication, with one another, via said retention clip, and allows the generation of a signal, and if also the removal of its distal end from the connection port places the first and second electrical contacts out of electric communication, with one another.

On the other hand, it is understood that an insertion tool would be in a “non-functional”—that is to say “defective”—state if the first and second contacts do not enter into electric communication with one another while the distal end of the insertion tool is properly disposed between a contact element and the retention clip that locks it.

According to the invention, the checking tool is a tool for checking an insertion tool, characterised in that:
the checking tool comprises an open electrical circuit, having a first electrical contact and a second electrical contact,
the electrical circuit is capable of being closed via an electrical contact of a non-defective insertion tool, and of generating a signal.

Thus, the signal can be taken as an indication that the insertion tool is not defective.

Advantageously, the positioning of the first and second electrical contacts of the checking tool corresponds to a depth of insertion of the insertion tool in a connection port necessary to lock a contact element in a connector by a retention clip disposed in such a port.

According to one embodiment,
said first electrical contact of the circuit corresponds to a distal end of an electrical contact, said electrical contact being disposed at a distal end of an insertion tool,
said second electrical contact of the circuit corresponds to a conductive region of the insertion tool, said conductive region being in electric communication with the distal end of the electrical contact of the insertion tool when:
the insertion tool is in a functional state,
the distal end of the insertion tool is inserted into a retention clip retaining a contact element of an electrical connector.

Thus, the checking tool allows to determine whether the insertion tool is defective between the regions in electric communication with the first and second electrical contacts of the circuit.

According to one embodiment, the second electrical contact of the circuit corresponds to a proximal end of the electrical contact of the insertion tool.

Thus, the checking tool allows to detect the wear or the degradation of the electrical contact of the insertion tool caused by the insertion of its distal end into the retention clip.

According to one embodiment,
the second electrical contact corresponds to a second electrical contact of the insertion tool,
the second electrical contact of the circuit corresponds to one end, distal, of a second electrical contact of the insertion tool,
the circuit comprises a third electrical contact in electric communication with a fourth electrical contact, to connect proximal ends of the first and second electrical contacts of the insertion tool.

Thus, the checking tool allows to detect any electrical defect in the insertion tool.

Moreover, it is noted that an insertion tool can be considered to be in a “non-functional”/“defective” state if its first and second contacts remain in electric communication with one another while the distal end of the insertion tool is not disposed between a contact element and the retention clip locking it.

According to one embodiment,
the checking tool comprises an open electrical circuit, having two electrical contacts,
said two electrical contacts of the circuit correspond to two electrical contacts of the insertion tool, the two electrical contacts of the insertion tool being insulated from one another when the insertion tool is in a non-defective state,
said electrical circuit is capable of being closed via the two electrical contacts of a defective insertion tool.

Thus the checking tool allows to detect whether the insertion tool is no longer reliable because of an electrical continuity between its first and second electrical contacts which would allow to falsely indicate the locking of a contact element by a retention clip.

Advantageously, the checking tool further includes an additional member for indicating the proper locking of the contact element in the clip.

Indeed, according to the embodiments described above, the confirmation is carried out only when the metallised parts of the pen are made to conduct via the (metal) retention clip. However, according to the ranges of connectors, the clips do not necessarily have the same dimensions. The checking tool must therefore be able to function on as many connectors as possible.

Preferably, this member is composed of an outer sheath mobile in translation along the case and encloses:
two pairs of secondary electrical contacts, one belonging to the sheath and the other to the case, and
a compression spring located between the pen and the case, said spring being tared to a stiffness-coefficient value such that the pairs of secondary electrical contacts remain open while the spring is not stopped, and are closed when the spring is stopped.

Thus, a second condition is therefore necessary to guarantee the correct plugging of a contact element into its cell. This second condition corresponds to a measurement of stress (or of force) of insertion. When these two conditions are met, in particular continuity of the metallised tracks on the pen and insertion stress reached, then the contact can be considered to be locked in its cell. Since the stress to be applied for the secondary electrical contacts to be closed (in contact with one another) is defined by the spring, it is therefore a set value to be reached. When the stress is reached (compression of the spring up to the stop), the two secondary electrical contacts installed on each part enter into contact. This contact is achieved when the operator reaches a stop during the insertion with the tool. Indeed, the pen is blocked in the cell while the operator pushes on the case and compresses the spring until the electrical contact is made.

These two conditions must be met since:
it is possible for the spring to be compressed before being stopped and to send the information. Indeed, the cells of the connectors are composed of a plurality of parts and are not smooth. Thus during the insertion, the end of the contact element (in particular sockets) can be blocked at the interface between the grommet and the insulant for example. In this case the spring indicates that the contact element is stopped (first condition met) however the end of the pen does not detect the clip (second condition not met).
According to the height of the clips, the end of the pen can detect its arrival in the retention clip for a clip that goes up very high. However the contact element is not necessarily locked. It would be necessary for the operator to push more axially on the tool for the condition of the stress to be validated and for the tool to indicate to the operator that the contact element is correctly plugged in.

Of course the compression spring can be replaced by an equivalent, for example another type of stop indicator or a stress sensor.

### BRIEF DESCRIPTION OF THE DRAWINGS

Other advantages, goals and particular features of the present invention will be clear from the non-limiting description that follows of at least one specific embodiment of the devices forming objects of the present invention, with regard to the appended drawings, in which:

FIGS. 1a-c show insertion tools,

FIGS. 2-5 show transverse cross-sectional views of a connection port,

FIGS. 6a-b show views of an insertion tool in a checking tool, and

FIGS. 7a-b show an improvement of FIG. 1c.

### DETAILED DESCRIPTION OF EMBODIMENTS OF THE INVENTION

The present description is given as non-limiting, each feature of an embodiment being able to be advantageously combined with any other feature of any other embodiment.

It is noted, as of now, that the drawings are not to scale.

FIG. 5 shows an insertion tool according to the invention inserted into a connection port of a connector.

The connection port is provided with a retention clip 5555 for locking a wire 4446 of an electrical cable. For this purpose, and in a known manner, the wire 4446 carries, on its ending, a contact element 4444, the geometry of which corresponds to that of the retention clip 5555.

It is known in the art to connect and to lock a cable thus provided with a contact element to an electrical connector by inserting the contact element 4444 into the retention clip 5555, and by moving the contact element 4444 forward in the retention clip 5555 up to a certain insertion depth, at which one or more strips 5556 of the retention clip, deformed during the forward movement of the contact element 4444, extend towards the inside of the retention clip 5555, thus retaining the contact element 4444 by preventing its possible backward movement. That is to say, the strips 5556 extending towards the inside of the retention clip 5555 lock the contact element 4444 in the connection port. Accordingly, the wire of the electrical cable 4446 is locked to the electrical connector.

The confirmation method forming an object of the invention allows to confirm whether the contact element 4444 is locked by the retention clip 5555 using a signal that can be transmitted when a condition corresponding to the retention or to the locking is met. This condition can be, for example, an extension of a strip 5556, and/or access to the insertion depth by the contact element 4444. When the condition is met, a circuit is closed via the retention clip 5555. This circuit comes into play at an insertion tool, particularly an insertion tool according to the invention.

The insertion tool comprises a first electrical contact 1114 and a second electrical contact 1115. The first 1114 and second 1115 electrical contacts are electrically insulated, from one another, when the insertion tool is not inserted into the retention clip 5555. However, when the insertion tool is inserted into the retention clip 5555, and when the retention clip 5555 retains the contact element 4444, the first 1114 and second 1115 electrical contacts of the insertion tool are placed in electric communication, with one another, via the retention clip 5555, and a signal is generated to indicate that the condition has been met. That is to say, when the insertion tool is inserted into the retention clip 5555 and when a contact element 4444 is locked by the retention clip 5555, a signal is generated between the first 1114 and second 1115 electrical contacts of the insertion tool to indicate that the condition has been met.

It is noted that the locking of a contact element 4444 by a retention clip 5555 into which it is already inserted can be confirmed by inserting an insertion tool according to the invention between the contact element 4444 and the retention clip 5555. It is also noted that it can be determined, during the initial insertion of the contact element 4444 into a retention clip 5555, whether it is correctly inserted and thus locked. In both cases, the distal end 1113 of the insertion tool ends up disposed between the contact element 4444 and the retention clip 5555.

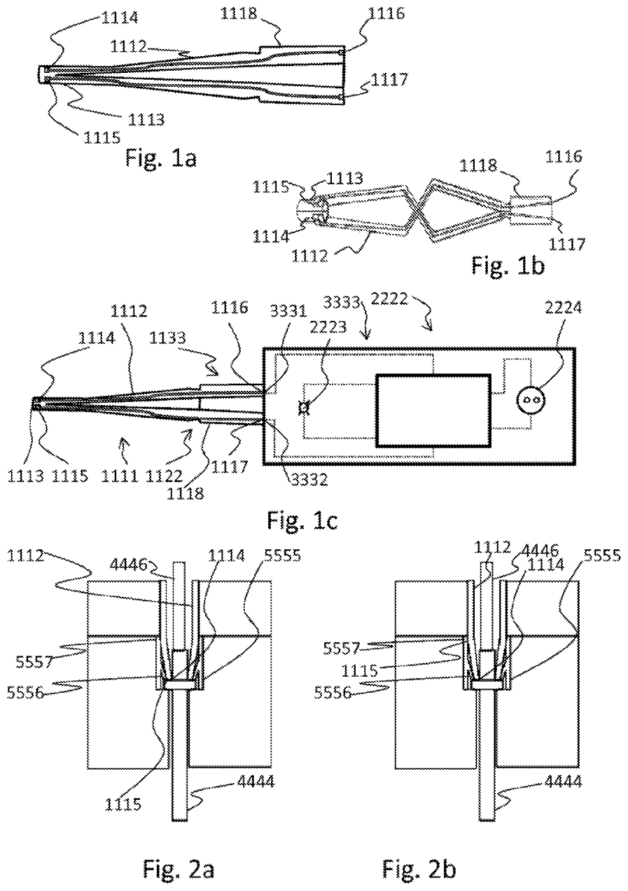

FIG. 1a shows an insertion tool according to an embodiment of the invention. FIG. 1b shows an insertion tool according to another embodiment of the invention.

The insertion tool comprises an elongated section 1112 made for the most part from plastic or another insulating material.

The insertion tool comprises a plurality of electrical contacts, a first 1114 of which is disposed at a distal end 1113 of the insertion tool and electrically insulated from a second 1115.

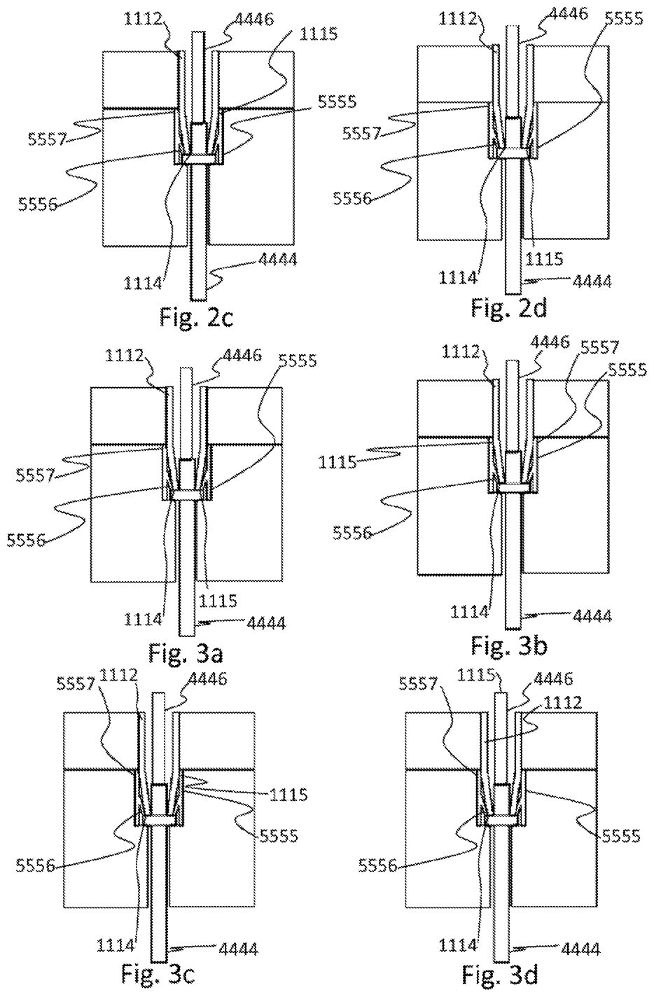

During its use, whether it is to mount an electrical connector or whether it is to confirm the proper insertion of a contact element and/or its locking in the electrical connector, the distal end 1113 is inserted into a connection port in the electrical connector. For this purpose, the distal end 1113 is dimensioned according to the size of the connector and of its components, in particular a retention clip 5555 with which the connection port is provided, an electrical wire 4446 to be connected and a contact element 4444 disposed on its ending. In particular, the distal end 1113 is dimensioned to be inserted between the proximal end 5557 of the retention clip 5555 disposed in the connection port and the proximal end of the contact element 4444 at the ending of the electrical wire 4446 to be connected, as visible in FIGS. 2-4.

It is understood that, when a wire 4446 of an electrical cable includes a contact element 4444 at its ending, the wire 4446 extends from a proximal end 4445 of the contact element 4444. It is also understood that, when a contact element 4444 is locked in a connector by a retention clip 5555 disposed in a connection port of the electrical connector, the contact element 4444 extends from the distal end of the retention clip 5555.

FIGS. 2-4 clearly show that the elongated section 1112 comprises an outer surface and an inner surface. When the distal end 1113 is positioned between the contact element 4444 and the retention clip 5555, an outer surface of the elongated section 1112 is disposed towards the retention clip, while an inner surface of the elongated section 1112 is disposed towards the contact element and/or towards the electrical wire 4446.

The introduction of the distal end 1113 into the retention clip 5555 causes an entry into electric communication between the first 1114 and second 1115 electrical contacts via a conductive material of the retention clip 5555, and the generation of a signal. This particular signal is not generated when the first electrical contact 1114 is not in electric communication with the second electrical contact 1115. The presence of this particular signal can therefore be considered as an indication that a condition is met. This condition depends on the positions of the first 1114 and second 1115 electrical contacts.

In FIG. 2a-d, the first electrical contact 1114 is disposed on the distal end 1113 in such a way as to enter into electric communication with the contact element 4444 without entering into electric communication with the retention clip 5555. That is to say, an insulating region separates the first electrical contact 1114 from the outer surface of the elongated section 1112.

In FIGS. 2a and 2d, the second electrical contact 1115 is also disposed on the distal end, but in such a way as to enter into electric communication with a strip 5556 of the retention clip 5555 without entering into electric communication with the contact element 4444. That is to say, an insulating region separates the second electrical contact 1115 from a surface of the insertion tool in contact with the contact element 4444. Once the contact element 4444 is locked in the connector by the retention clip, the strip 5556 enters into electric communication with the contact element 4444 and the second electrical contact 1115, thus placing the first 1114 and second 1115 electrical contacts in electric communication. Thus, it is the extension of the strip 5556 towards the inside of the retention clip 5555, which is used to lock the contact element 4444 in the electrical connector, that is also used to place the first 1114 and second 1115 electrical contacts in electric communication, with one another.

It is understood that, when an electrical wire 4446, including a contact element 4444 at its ending, is connected to an electrical connector via a retention clip 5555 disposed in a connection port of the electrical connector, a distal end of a strip 5556 of the retention clip 5555 extends towards the centre of the retention clip, in such a way as to make the internal geometry of the retention clip 5555 smaller than an external geometry of the contact element 4444.

In FIGS. 2b-c, the second electrical contact 1115 is disposed at the distal end 1113 in such a way as to enter into electric communication with the proximal end 5557 of the retention clip 5555. That is to say, the second electrical contact 1115 is proximal to the first electrical contact 1114 and disposed on an outer surface of the elongated section 1112. Once the insertion tool accesses an insertion depth in the retention clip 5555 corresponding to a proper insertion of the contact element 4444, and thus to the locking of the latter in the connector, the second electrical contact 1115 enters into electric communication with the proximal end 5557 of the retention clip 5555, and thus enters into electric communication with the first electrical contact 1114 as well.

In FIG. 3a-d, the first electrical contact 1114 is disposed on the distal end 1113 in such a way as to enter into electric communication with a strip 5556 of the retention clip 5555 without entering into electric communication with the contact element 4444. That is to say, an insulating region separates the first electrical contact 1114 from a surface of the insertion tool in contact with the contact element 4444.

In FIG. 3a, the second contact is also disposed on the distal end 1113 in such a way as to enter into electric communication with a strip 5556 of the retention clip 5555 without entering into electric communication with the contact element 4444. That is to say, an insulating region separates the second electrical contact 1115 from a surface of the insertion tool in contact with the contact element 4444. Once the contact element 4444 is properly inserted into the retention clip 5555, one or more strips 5556 extend towards the inside of the retention clip 5555, thus locking the contact element 4444 in the connection port. When the strip(s) 5556 extend towards the inside of the retention clip 5555, they enter into electric communication with the first 1114 and second 1115 electrical contacts, thus placing the first 1114 and second 1115 electrical contacts in electric communication with one another.

In FIGS. 3b-c, the second electrical contact 1115 is disposed at the distal end 1113 in such a way as to enter into electric communication with the proximal end 5557 of the retention clip 5555. That is to say the second electrical contact 1115 is proximal to the first electrical contact 1114 and disposed on an outer surface of the elongated section 1112. Once the insertion tool accesses an insertion depth in the retention clip corresponding to the proper insertion of the contact element, and thus to the locking of the latter in a connection port by a retention clip, the second electrical contact 1115 enters into electric communication with the proximal end 5557 of the retention clip 5555, and thus enters into electric communication with the first electrical contact 1114, in electric communication with the strip 5556.

In FIGS. 3d and 4b, the second electrical contact 1115 is disposed in such a way as to enter into electric communication with the conductor of the wire 4446. Once the insertion tool accesses an insertion depth in the retention clip 5555 corresponding to the proper insertion of the contact element, and thus to the locking of the latter in a connection port by a retention clip, the second electrical contact 1115 enters into electric communication with the retention clip 5555, and thus enters into electric communication with the contact element 4444 and the conductor of the electrical wire 4446 to which it is attached.

In FIG. 3d, the electric communication is established between the first electrical contact 1114 and the second electrical contact 1115 via the strip 5556 of the retention clip 5555, then the contact element 4444 and then the conductor of the electrical wire 4446. The involvement of the strip 5556 in the electric communication between the first 1114 and second 1115 contacts allows the direct detection of the locking of the contact element 4444 by the retention clip 5555. However, in FIG. 4b, the electric communication is established between the first electrical contact 1114 and the second electrical contact 1115 via the proximal end 5557 of the retention clip 5555, then the strip 5556 of the retention clip, then the contact element 4444 and then the conductor of the electrical wire 4446. This configuration allows the deduction of the locking of the contact element 4444 by the retention clip 5555 via the insertion depth reached by the insertion tool.

In FIGS. 4a-b, the first electrical contact 1114 is disposed at the distal end 1113 in such a way as to enter into electric communication with the proximal end 5557 of the retention clip 5555. That is to say, the first electrical contact 1114 is disposed on an outer surface of the elongated section 1112.

In FIG. 4a, the second electrical contact 1115 is also at the distal end 1113, substantially at the same level of the first electrical contact 1114. The second electrical contact is also disposed on an outer surface of the elongated section 1112, in such a way as to enter into electric communication with the proximal end 5557 of the retention clip 5555. Once the insertion tool accesses an insertion depth in the retention clip 5555 corresponding to the proper insertion of the contact element 4444, and thus to the locking of the latter by the retention clip, the first electrical contact 1114 enters into electric communication with the second electrical contact 1115 via the retention clip 5555.

As explained above, the signal generated when the first 1114 and second 1115 electrical contacts have entered into electric communication can be considered to be an indication that a certain condition has been met, and it can be considered that the definition of this condition depends on the positioning of the first 1114 and second 1115 electrical contacts.

In FIGS. 2a, 2d, 3a and 3d, the first 1114 and second 1115 electrical contacts are in electric communication when the flange of the contact element 4444 has gone beyond the strip 5556 of the retention clip 5555 and thus when the contact element 4444 is locked by the retention clip 5555. These arrangements of the first 1114 and second 1115 electrical contacts are suitable for a plurality of geometries of the retention clip 5555 because the electric communication is established at the mechanical interaction locking the contact element 4444 in the retention clip 5555.

In FIGS. 2b-c, 3b-c and 4a-b, the first 1114 and second 1115 electrical contacts are in electric communication when the contact element 4444 reaches an insertion depth in the retention clip 5555 that corresponds to the flange of the contact element 4444 going beyond the strip 5556 and thus to the locking of the contact element 4444 by the retention clip 5555. These arrangements of the first 1114 and second 1115 electrical contacts each require a particular geometry of the conductive part of the retention clip 5555. If the distance between its proximal end 5557 and the distal end of its strip 5556 is too great, the first 1114 and second 1115 electrical contacts enter into electric communication before the contact element 4444 is locked by the retention clip 5555. However, if the distance is too small, the first 1114 and second 1115 electrical contacts do not enter into electric communication even if the contact element 4444 is locked by the retention clip 5555. On the other hand, when this distance is correct, the electric communication between the first 1114 and second 1115 is not established before the insertion tool reaches the insertion depth necessary to move the flange of the contact element 4444 forward beyond the distal end of the strip 5556 of the retention clip 5555. That is to say, when the arrangement of the first 1114 and second 1115 electrical contacts of the insertion tool correctly corresponds to the distance between the distal end of the strip 5556 and the proximal end 5557 of the retention clip, the electric communication between the first 1114 and second 1115 electrical contacts is established when the contact element 4444 is locked by the retention clip 5555 and is not established when the contact element 4444 is not locked by the retention clip 5555.

The arrangements of the first 1114 and second 1115 electrical contacts shown in FIGS. 3d and 4b greatly reduce the risk of falsely indicating a proper connection of the wire 4446 of an electrical cable or locking of the contact element 4444 because the second contact 1115 is in electric communication with the wire 4446.

The arrangements of the first 1114 and second 1115 electrical contacts shown in FIGS. 2a-d greatly reduce the risk of falsely indicating a proper connection of the wire 4446 of the electrical cable or locking of the contact element 4444 because the first electrical contact 1114 is in electric communication with the contact element 4444 and the second electrical contact 1115 is in electric communication with the retention clip 5555.

The arrangements of the first 1114 and second 1115 electrical contacts shown in FIGS. 2a-d, 3a-c and 4a allow to simplify the structure and the use of the insertion tool because the first 1114 and second 1115 electrical contacts are both disposed on the elongated section 1112.

The arrangements of the first 1114 and second 1115 electrical contacts shown in FIGS. 3a-c and 4a simplify the manufacturing of the insertion tool because each of the first 1114 and second 1115 electrical contacts is disposed on an outer surface of the elongated section 1112.

Any electrical contact disposed at the distal end 1113 of the insertion tool is substantially thin, in such a way as to not disturb the insertion of the distal end 1113 between the retention clip 5555 and the contact element 4444.

There are a plurality of methods for obtaining a thin electrical contact on the plastic material of the elongated section. For example, a metal layer can be deposited on the plastic. The geometry of this layer can be defined for example by a selective surface treatment, or by a rather general surface treatment followed by the removal of conductive material to define insulating regions.

A first electrical contact 1114 is disposed at the distal end 1113. The first electrical contact 1114 is electrically insulated from a second electrical contact 1115. There are numerous possible arrangements of the first 1114 and second 1115 electrical contacts. Some are presented in FIGS. 2-4. In general, the first 1114 and second 1115 electrical contacts are disposed in such a way as to be in electric communication, with one another, via the retention clip 5555 when the retention clip locks a contact element 4444 and the distal end 1113 reaches an insertion depth in the retention clip corresponding to the proper insertion of the contact element 4444 in the retention clip 5555.

It is important to note that the insertion tool shown in FIGS. 2-4 can have a shape of the “pen” type, with a body having an elongated section 1112, a shape of the “clamp” type, with a plurality of bodies having an elongated section 1112, or another shape. In the case of a shape of the “pen” type, FIGS. 2a-b and 3b show the first 1114 and second 1115 electrical contacts disposed substantially on the same side of the body, while FIGS. 2c-d, 3a, 3c and 4a show the first electrical contact 1114 disposed substantially on the other side of the body from the second electrical contact 1115. In the case of a shape of the “clamp” type, FIGS. 2a-b and 3b show the first 1114 and second 1115 electrical contacts disposed on the same body, while FIGS. 2c-d, 3a, 3c and 4a show the first electrical contact 1114 disposed on another body than the second electrical contact 1115.

In FIG. 1a, an insertion tool according to the invention is visible, having a shape of the “pen” type, with a body having an elongated section 1112.

It has, at its distal end 1113, an opening capable of receiving a contact element 4444. The width or the diameter of the opening corresponds to the external geometry of the contact element 4444.

This opening opens onto a hollow at the bottom of a longitudinal groove. At the distal end, the width or the diameter of the hollow corresponds to the local size of the electrical wire 4446 attached to the contact element 4444. When a contact element 4444, mounted at the ending of an electrical wire 4446, is disposed in the distal end 1113, a part of the wire 4446 is disposed in the hollow, and extends from the longitudinal groove. According to one embodiment, at the distal end 1113, the width of the longitudinal groove is less than the width or the diameter of the opening and/or of the hollow. Via the flexibility of the elongated section, the insertion tool can clip onto the electric wire 4446, which facilitates the manipulation of the insertion tool. The insertion tool pushes on the contact element 4444 at a proximal end 4445 of the latter. Advantageously, the distal end 1113 of the insertion tool pushes on the interface between the contact element 4444 and the wire 4446 or on the proximal surface of a flange of the contact element 4444 disposed towards the proximal end 4445 of the contact element 4444. When the contact element is properly inserted, and thus locked by the retention clip 5555, the insertion tool can be removed by sliding the elongated section 1112 on the electric wire 4446 in such a way as to move it away from the contact element 4444. When it is desired to confirm the locking of a contact element 4444 that is already mounted in an electrical connector, the insertion tool can be guided to the connection port by sliding the elongated section 1112 on the wire 4446 towards the contact element 4444.

The distal end 1113 is intended to be inserted into a retention clip 5555. The width or the outer diameter of the distal end 1113 corresponds to the internal geometry of a proximal end 5557 of the retention clip 5555.

In FIG. 1b, an insertion tool according to the invention is visible, having a shape of the “clamp” type with a plurality of bodies having an elongated section 1112.

At the distal end 1113, each body is configured to be inserted between a contact element 4444 and the retention clip 5555. Each body is also configured to thus be inserted at the same time as another body of the same insertion tool. For example, if the insertion tool comprises two bodies, the two bodies are configured to be inserted between the contact element 4444 and the retention clip 5555 at the same time.

The bodies are configured to receive an electrical contact element 4444 between their inner surfaces at the distal end 1113 of the elongated section 1112. When a contact element 4444 is disposed at the distal end 1113, a part of the electrical wire 4446 to which the contact element 4444 is attached is disposed between the inner surfaces of the bodies.

In FIG. 1c, an insertion tool according to the invention comprising two parts is visible. The first part 1111 comprises the first 1114 and second 1115 electrical contacts. The second part 2222 comprises an electric system 3333 connecting the first 1114 and second 1115 electrical contacts to a source of electric energy. For this purpose, the electric system 3333 comprises a third electrical contact 3331 and a fourth electrical contact 3332, for entering into electric communication with the first 1114 and second 1115 electrical contacts, respectively.

Preferably, the electric system 3333 comprises a means for detecting electric communication between the third 3331 and fourth 3332 electrical contacts, as well as a signalling means 3335 for signalling the detection of the electric communication between the third 3331 and fourth 3332 electrical contacts. When the first part 1111 is attached to the second part, the establishment of electric communication between the first 1114 and second 1115 electrical contacts also establishes an electric communication between the third 3331 and fourth 3332 electrical contacts.

Preferably, the signalling means comprises an emitter of a sensory and/or computer signal.

In FIG. 1c, the third 3331 and fourth 3332 electrical contacts are in electric communication with the first 1114 and second 1115 electrical contacts via the second ending 1116 of the first conductive track and the second ending 1117 of the second conductive track, respectively. The endings 1116 and 1117 of the first and second conductive tracks are part of first part 1111 of the insertion tool, and are respectively in electric communication with the first 1114 and second 1115 electrical contacts. Preferably, the second endings of the first 1116 and second 1117 conductive tracks are at a distance from the first 1114 and second 1115 electrical contacts. Thus, the electrical connection between the first 1111 and second 2222 parts does not hide the first 1114 and second 1115 electrical contacts. The first conductive track is electrically insulated from the second conductive track.

FIG. 1c shows that the elongated section 1112 is mechanically attached, by its proximal end 1118, to a case via a linking means 1122. Preferably, as visible in FIG. 1c, at least a part of the electric system 3333 is disposed in this case. FIG. 1c shows that the case has a light 2223 and a buzzer 2224. The insertion tool as shown in FIG. 1c is thus compact and easy to manipulate by hand.

Preferably, the linking means 1122 comprises a means 1133 for connecting the electrical contacts of the first part 1111 to electrical contacts of the electric system 3333. For example, in FIG. 1c, the third 3331 electrical contact and the second ending 1116 of the first conductive track are disposed on corresponding surfaces of the linking means 1122, and the fourth 3332 electrical contact and the second ending 1117 of the second conductive track are disposed on corresponding surfaces of the linking means 1122.

In FIG. 1c, the third 3331 and fourth 3332 electrical contacts are presented on surfaces of the case in contact with the distal end 1118 of the first part 1111, and the second endings of the first 1116 and second 1117 conductive tracks are presented on surfaces of the first part in contact with the case, in particular that or those having the third 3331 and fourth 3332 electrical contacts.

Preferably, the first 1111 and second 2222 parts are removably connected. Thus, if one of the parts is defective, it is easily replaceable.

In FIG. 1c, if the elongated section 1112 is separated from the case, the first 1114 and second 1115 contacts are also disconnected from the electric system 3333. Likewise, if the elongated section is mounted to the case, the first 1114 and second 1115 contacts are also connected to the electric system 3333.

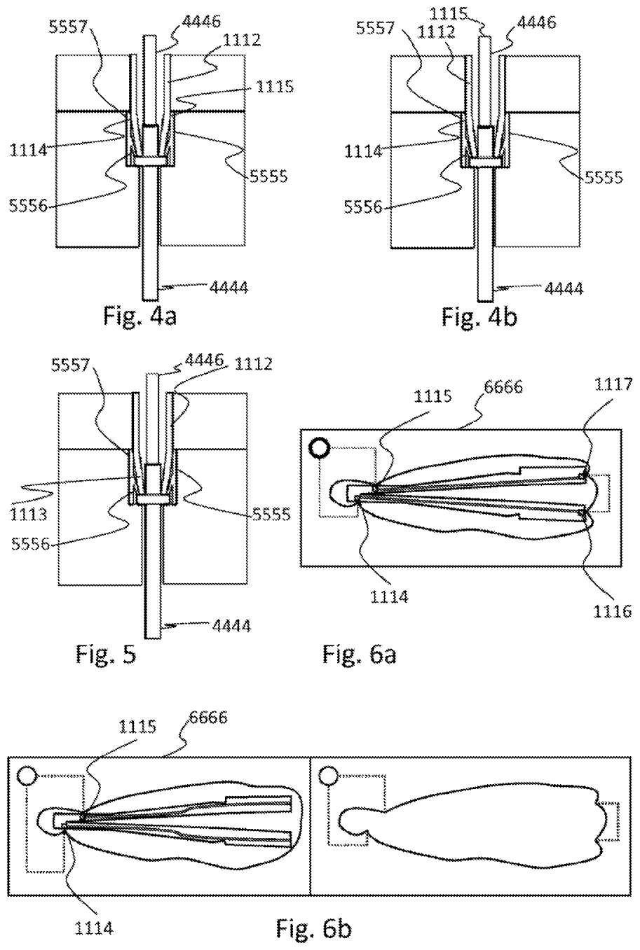

To implement the confirmation method forming an object of the invention using the insertion tool forming an object of the invention, it is important for the latter to not be defective. For example, if the retention clip 5555 rubs a contact of the insertion tool, this rubbing can cause the removal or the migration of the conductive material, in this way the insertion tool will no longer be reliable. FIG. 6a shows a view of an insertion tool according to the invention in a checking tool 6666 during a checking method. The checking tool 6666 comprises at least two electrical contacts and an open circuit. The circuit is closed in the presence of an insertion tool according to the invention in a non-defective state. A signal is generated when the circuit of the checking tool is closed to indicate the proper operation of the insertion tool.

The electrical contacts of the checking tool correspond to key positions of the insertion tool and their arrangement determines the type of defect to be detected. For example, if the electrical contacts of the checking tool correspond to opposite ends of a single electrical contact of the insertion tool, the circuit of the checking tool is closed if there is conductive material connecting these ends. Likewise, if the electrical contacts of the checking tool correspond to points of the insertion tool that are in electric communication with one another permanently in the case of a non-defective insertion tool, the circuit of the checking tool is closed when there is conductive material connecting these points. According to one embodiment, the checking tool 6666 comprises at least four electrical contacts, corresponding to opposite ends of the first and second conductive tracks. That is to say two electrical contacts of the checking tool 6666 correspond to opposite ends of the first conductive track, and two other electrical contacts of the checking tool 6666 correspond to opposite ends of the second conductive track.

For example, the second ending can be considered to be an end of a conductive track, and an end of a contact can be considered to be an opposite end of this first end. Thus, one electrical contact of the checking tool corresponds to the distal end of the first electrical contact 1114, two electrical contacts of the checking tool correspond to the second endings of the first 1116 and second 1117 conductive tracks, and one electrical contact of the checking tool corresponds to the end of the second electrical contact 1115 opposite to the second ending 1117 of the second conductive track. In this embodiment, the circuit is closed when there is no break of continuity in the conductive material between the first 1114 electrical contact and the second ending 1116 of the first conductive track, nor in the conductive material between the second ending 1117 of the second conductive track and the end of the second electrical contact 1115 opposite to the second ending 1117 of the second conductive track.

According to one embodiment the checking tool comprises an open circuit having two electrical contacts in communication, with one another, said two contacts corresponding to opposite ends of the first 1114 and second 1115 electrical contacts of the first part 1111 of the insertion tool. When the first part 1111 is inserted into the checking tool 6666, the first part 1111 being connected to the second part 2222, the electric system 3333 of the second part 2222 detects the electric communication between the third 3331 and fourth 3332 contacts via the first 1114 and second 1115 electrical contacts, and emits a sensory and/or computer signal via the signalling means. In the context of such a checking method, this sensory and/or computer signal is considered to be an indication of the absence of breaks in the conductive material of the insertion tool.

According to one embodiment, the checking tool comprises an open circuit, having two electrical contacts in electric communication, with one another, said two contacts corresponding to the first 1114 and second 1115 electrical contacts of the insertion tool. This circuit is closed if the first 1114 and second 1115 electrical contacts of the insertion tool are electrically connected. This can occur, for example, if a conductive material migrates into an insulating region of the insertion tool in such a way as to connect its first 1114 and second 1115 electrical contacts. A signal is generated when this circuit is closed to indicate a defect in the insertion tool. Advantageously, the checking tool 6666 comprises this circuit as well as the circuit shown in FIG. 6a. FIG. 6b shows a view of an insertion tool according to the invention in a checking tool 6666, during a checking method, comprising two electrical circuits: a first circuit to detect a gap in the conductive material of the insertion tool (on the right, as visible in FIG. 6a), and a second circuit to detect an electrical continuity between the first 1114 and second 1115 electrical contacts through the insulating region separating them.

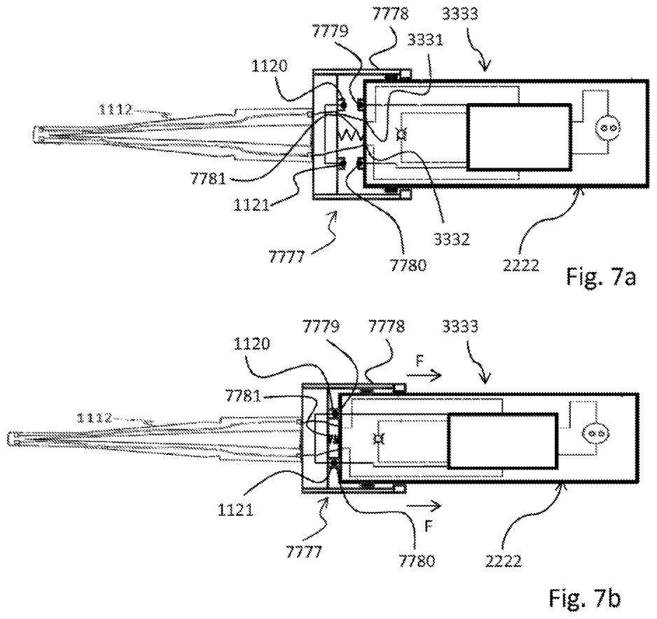

According to an improvement illustrated in FIGS. 7a and 7b, the checking tool includes an additional member 7777 for indicating the proper locking of the contact element 4444 in the clip 5555.

More precisely, this member 7777 includes an outer sheath 7778 mobile in translation in such a way as to be able to slide along the case 2222.

This outer sheath 7778 encloses first of all a first pair of secondary electrical contacts 1120 and 1121 and a second pair of secondary electrical contacts 7779 and 7780 connected to the electric system 3333 of the case 2222.

Finally, the outer sheath 7778 encloses a compression spring 7781 having a stiffness-coefficient value (taring) such that the pairs of secondary electrical contacts 1120 and 1121 and 7779 and 7780, respectively, remain open as long as the spring 7781 is not stopped (FIG. 7a), and are closed when the sheath 7778 has moved backward sufficiently (arrows F) along the case 2222 and the spring 7781 is stopped (FIG. 7b).

Of course the electrical continuity is always ensured between the first electrical contacts 1114 and 1115 of the pen and the third 3331 and fourth 3332 contacts of the electric system 3333, respectively.

This second condition related to the compression spring allows to guarantee the correct plugging of a contact element into its cell. Thus, when these two conditions are met, in particular continuity of the metallised tracks on the pen and insertion stress reached, then the contact can be considered to be locked in its cell. Since the stress to be applied for the secondary electrical contacts to be closed (in contact with one another) is defined by the spring, it is therefore a set value to be reached. When the stress is reached (compression of the spring up to the stop), the pairs of secondary electrical contacts installed on each part come into contact. This contact is achieved when the operator reaches a stop during the insertion with the tool, and only at that moment.

1. Method for confirming the locking of a contact element of a wire or of an electrical cable by a retention clip in an electrical connector, wherein:
one end, distal, of an elongated section of an insertion tool is inserted between the retention clip and one end of the contact element, the insertion tool comprising a first electrical contact, disposed at said distal end, and a second electrical contact; and
the first electrical contact is placed in electric communication with the second electrical contact via the retention clip when the contact element is locked in the retention clip, said first electrical contact being electrically insulated from said second electrical contact before the insertion of the insertion tool into said retention clip.

2. The method according to claim 1, carried out during a method for mounting the contact element in the retention clip of the electrical connector, wherein
said contact element is inserted into said retention clip using the distal end (1113) of the elongated section of the insertion tool; and
said contact element is moved forward in said clip using said insertion tool until the contact element is locked in the connector by the retention clip and the distal end of the insertion tool is disposed between the retention clip and the contact element.

3. The method according to claim 1, comprising a method for checking the insertion tool, wherein:
the electrical insulation of the first electrical contact of the insertion tool and of the second electrical contact of the insertion tool is checked; and
the electrical continuity at the first electrical contact is confirmed.

4. The method according to claim 3, wherein the method for checking the insertion tool comprises a step in which:
an electrical circuit is closed via the first electrical contact of the insertion tool.

5. An insertion tool for an electrical connector, capable of implementing a confirmation method according to claim 1, said tool comprising an elongated section, one end of which, distal, is intended to be inserted into a connection port for a contact element of a wire of an electrical cable in the connector, the connection port being provided with a retention clip, the connector comprising one or more connection ports, and at least a part of the elongated section is insulated, said insertion tool comprising:
a first electrical contact, disposed at the distal end of the elongated section; and
a second electrical contact, electrically insulated from the first electrical contact;
said first and second electrical contacts being capable of entering into electric communication with one another when the distal end is inserted into the retention clip.

6. The insertion tool for an electrical connector according to claim 5, wherein said first and second electrical contacts are capable of entering into electric communication with one another when the distal end is inserted into the connection port and the contact element of the wire is locked by the retention clip.

7. The insertion tool according to claim 5, wherein the first electrical contact is disposed in such a way as to come in contact with the retention clip during the insertion of the distal end.

8. The insertion tool according to claim 5, further comprising a first part comprising the first and second electrical contacts, and a second part comprising an electric system, connecting the first electrical contact and the second electrical contact to a source of electric energy, the electric system comprising:
a third electrical contact to enter into electric communication with the first electrical contact, and
a fourth electrical contact, insulated from the third electrical contact, to enter into electric communication with the second electrical contact.

9. The insertion tool according to claim 8, wherein the electric system comprises:
a means for detecting electric communication between the third and fourth electrical contacts; and
a means for signalling said electric communication between the third and fourth electrical contacts.

10. The insertion tool according to claim 8, comprising a means for linking the elongated section to the second part.

11. The insertion tool according to claim 8, further comprising an additional member for indicating the proper locking of the contact in the clip.

12. The insertion tool according to claim 11, wherein the member is composed of an outer sheath mobile in translation along the case and enclosing:
two pairs of secondary electrical contacts, a first pair belonging to said sheath and the other belonging to said case, and
a compression spring located between the pen and the case, said spring being tared to a stiffness-coefficient value such that the pairs of secondary electrical contacts remain open as long as the spring is not stopped, and are closed when the spring is stopped.
